(19) United States
(12) Patent Application Publication
(10) Pub. No.: US 2014/0317379 A1
(43) Pub. Date: Oct. 23, 2014

(54) INFORMATION PROCESSING SYSTEM, CONTROL APPARATUS, AND METHOD OF CONTROLLING INFORMATION PROCESSING SYSTEM

(71) Applicant: FUJITSU LIMITED, Kawasaki-shi (JP)

(72) Inventor: Hiroyuki MIYAZAKI, Kawasaki (JP)

(73) Assignee: FUJITSU LIMITED, Kawasaki-shi (JP)

(21) Appl. No.: 14/228,297

(22) Filed: Mar. 28, 2014

(30) Foreign Application Priority Data
Apr. 18, 2013 (JP) 2013-087851

(51) Int. Cl. G06F 9/38

(52) U.S. Cl. CPC G06F 9/3885
USPC 712/29

(57) ABSTRACT

A parallel computer includes a plurality of processors connected through transmission paths to each other. A job management server determines a communication path passing transmission paths connecting a certain number of processors in accordance with jobs to be input among the processors, and inputs the jobs to the certain number of processors connected through the determined communication path. A link control server controls transmission/reception circuits of the processors connected through transmission paths not included in the communication path among the transmission paths connecting the processors.

### CROSS-REFERENCE TO RELATED APPLICATION

This application is based upon and claims the benefit of priority of the prior Japanese Patent Application No. 2013-087851, filed on Apr. 18, 2013, the entire contents of which are incorporated herein by reference.

### FIELD

The embodiment discussed herein is directed to an information processing system, a control apparatus, and a method of controlling information processing system.

### BACKGROUND

Conventionally, there is known a technique in which a parallel computer having a plurality of calculation nodes performs simulation by numerical calculation. Known examples of such a technique include a parallel computer system dividing calculation space that is an object of simulation to a plurality of areas and causing different calculation nodes to perform simulation of different divided areas.

The parallel computer system divides calculation space to a plurality of areas and regularly maps the divided areas to the calculation nodes. That is, the parallel computer system maps each divided area to a calculation node having positional relation same as that of the divided area. Then, the parallel computer system causes each calculation node to perform simulation of the area mapped to the calculation node, thus performing simulation of the entire calculation space.

Here, when the simulation of a phenomenon in three-dimensional space such as tsunami is performed, for example, divided areas of the three-dimensional space are significantly influenced by the adjacent areas. In the simulation in which the correlation between areas is stronger as a distance between the areas is shorter, a communication amount is increased as a distance between calculation nodes performing communication is shorter. Therefore, in the simulation of a phenomenon in three-dimensional space, the communication of each calculation node with its adjacent calculation nodes is significantly increased as compared with the communication with other calculation nodes. Therefore, the parallel computer system performs simulation efficiently using a plurality of calculation nodes connected through a direct interconnection network with topology of multi-dimensional orthogonal coordinates, for example.

Moreover, some parallel computer systems include a network in which calculation nodes are connected through a direct interconnection network with torus form (annular) topology. In this example, calculation nodes adjacent to each other, among a plurality of calculation nodes, are connected directly through links, and calculation nodes positioned at both ends of the network are connected directly through links. The calculation nodes connected in this manner, including even those at both ends, can perform communication at a higher speed as compared with the case of a direct interconnection network with mesh form topology. Therefore, the parallel computer system having nodes connected in a torus form can efficiently perform simulation even when a correlation exists between both ends of calculation space such as in simulation using periodic boundary conditions. Moreover, communication paths between calculation nodes are increased and thus a bisection band width is increased, which consequently decreases traffic between calculation nodes. Here, the bisection band width is a communication band width between divided calculation node groups when a parallel computer system having calculation nodes connected through a network is divided arbitrarily. In the parallel computer, it is important to design a bisection band width value not to be equal to or smaller than a certain value in order to secure the overall performance of the parallel computer.

As a technique for determining an information communication path of a parallel processor, there is a conventional technique in which information is sequentially transmitted to a node corresponding to a polygon having an edge that gives the shortest path to a transmission destination coordinate point among nodes corresponding to polygons including the transmission destination coordinate point.

Patent Document 1: Japanese Laid-open Patent Publication No. 01-156860

However, in the parallel computer system, the connection state of paths between nodes connected physically is secured to be same regardless of whether a communication amount is large or small on the paths. Therefore, an unnecessary bandwidth and transmission speed are secured for a path having a small communication amount and thus requiring only a small band width and a low transmission speed, which causes waste of power consumption.

Moreover, even with the use of a conventional technique in which a transmission destination is determined based on a distance between an edge of a polygon including a coordinate point of the transmission destination and the coordinate points, it is difficult to reduce power consumption.

### SUMMARY

According to an aspect of an embodiment, an information processing system, includes: an information processing device that includes a plurality of arithmetic processing units connected through transmission paths to each other; a management device that determines a communication path passing the transmission paths connecting a certain number of arithmetic processing units in accordance with jobs to be input among the arithmetic processing units, and inputs the jobs to the certain number of arithmetic processing units connected through the determined communication path; and a control apparatus that controls transmission/reception circuits of the arithmetic processing units connected through the transmission paths not included in the communication path among the transmission paths connecting the arithmetic processing units.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an information processing system according to an embodiment;

FIG. 2 is a diagram illustrating a six-dimensional coordinate axes;

FIG. 3 is a diagram for explaining interconnection paths between processors, and connection of service processors;

FIG. 4 is a diagram illustrating logical coordinate axes;

FIG. 5 is a diagram illustrating one example of logical connection when no failure occurs in processors;

FIG. 6 is a diagram illustrating one example of logical connection when a failure occurs in a processor;

FIG. 7 is a block diagram illustrating details of a parallel computer according to the embodiment;

FIG. 8 is a flowchart illustrating processing of degenerating lanes of interconnection paths in the information processing system according to the embodiment;

FIG. 9 is a flowchart illustrating processing of generating logical coordinates;

FIG. 10 is a block diagram illustrating details of a parallel computer according to a modification;

FIG. 11 is a diagram illustrating one example of a hardware configuration of a job management server and a link control server; and

FIG. 12 is a diagram illustrating one example of a hardware configuration of each node in the parallel computer.

### DESCRIPTION OF EMBODIMENT

Preferred embodiments of the present invention will be explained with reference to accompanying drawings. The following embodiment does not limit the information processing system, the control apparatus, and the method of controlling the information processing system of the application.

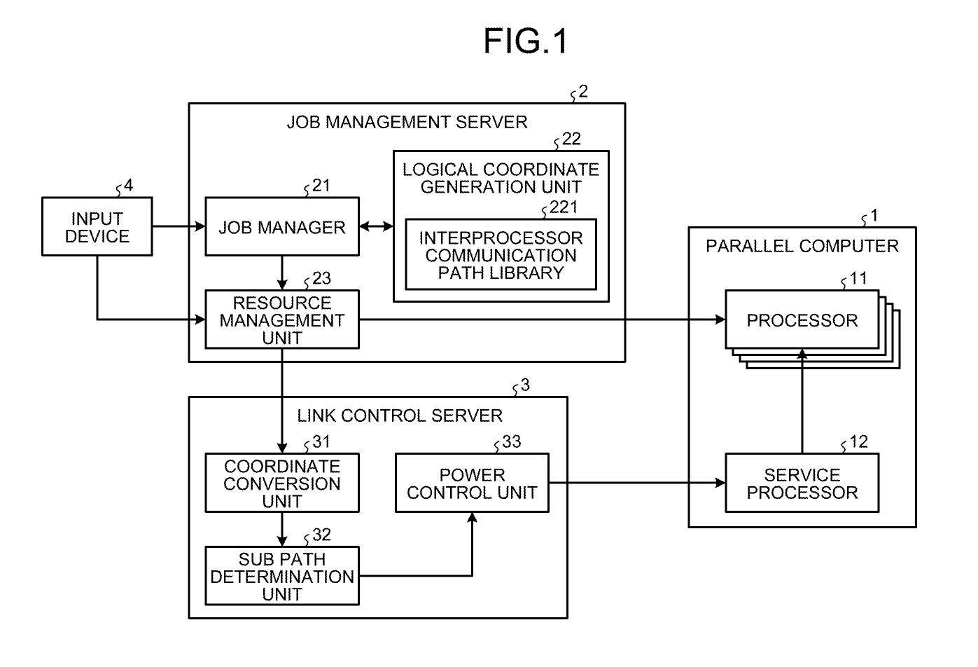

FIG. 1 is a block diagram illustrating an information processing system according to the embodiment. As illustrated in FIG. 1, the information processing system of the embodiment includes a parallel computer 1, a job management server 2, a link control server 3, and an input device 4.

The parallel computer 1 includes processors 11 as a plurality of arithmetic processing devices and service processors 12 as system control apparatuses.

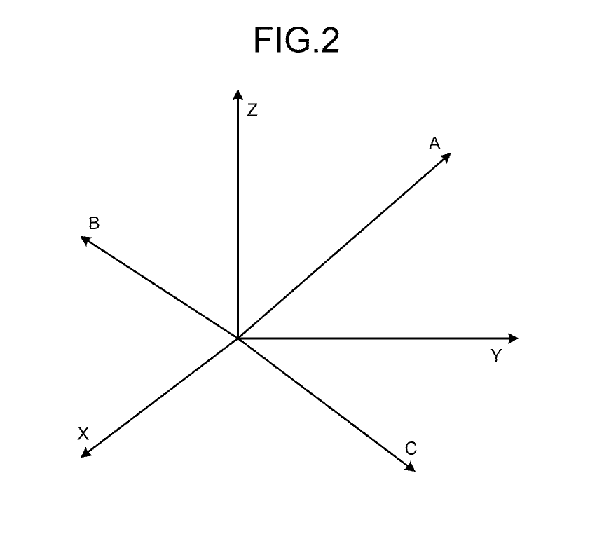

The processors 11 are arranged to have a plurality of coordinate axes. For example, in the embodiment, the position of the processor 11 in six-dimensional space is determined using positions of coordinate axes of X, Y, Z, A, B, and C, as illustrated in FIG. 2. FIG. 2 is a diagram illustrating six-dimensional coordinate axes. The coordinate axes X, Y, and Z form three-dimensional space. The coordinate axes A, B, and C are coordinate axes for securing redundancy of the processors 11 arranged in an X axis direction, a Y axis direction, and a Z direction, respectively. The processors 11 on the coordinate axis X and the processors 11 on the coordinate axis A are connected with three-dimensional torus connection topology. The processors 11 on the coordinate axis Y and the processors 11 on the coordinate axis B are connected with three-dimensional torus connection topology. The processors 11 on the coordinate axis Z and the processors 11 on the coordinate axis C are connected with three-dimensional torus connection topology. That is, the processors on an X-A plane are connected to one another with three-dimensional torus connection topology. The processors on a Y-B plane are connected to one another with three-dimensional torus connection topology. The processors on a Z-C plane are connected to one another with three-dimensional torus connection topology. For example, even when a failure occurs in some of processors 11 on the Y-B plane defined with the Y axis direction and the B axis direction, it is possible, with a three-dimensional torus defined with the Y axis and the B axis, to maintain connection between the processors 11 on the Y-B plane by bypassing the processor 11 having a failure. Here, although the processors 11 are arranged so that their positions can be specified in six-dimensional space, the coordinate axes are not fixed. That is, the X, Y, Z, A, B, and C are allocated dynamically in accordance with jobs to be executed so that regarding six directions of the processor 11, the X, Y, and Z axes are perpendicular to one another and the A, B, and C correspond to redundant directions of the X axis, the Y axis, and the Z axis, respectively.

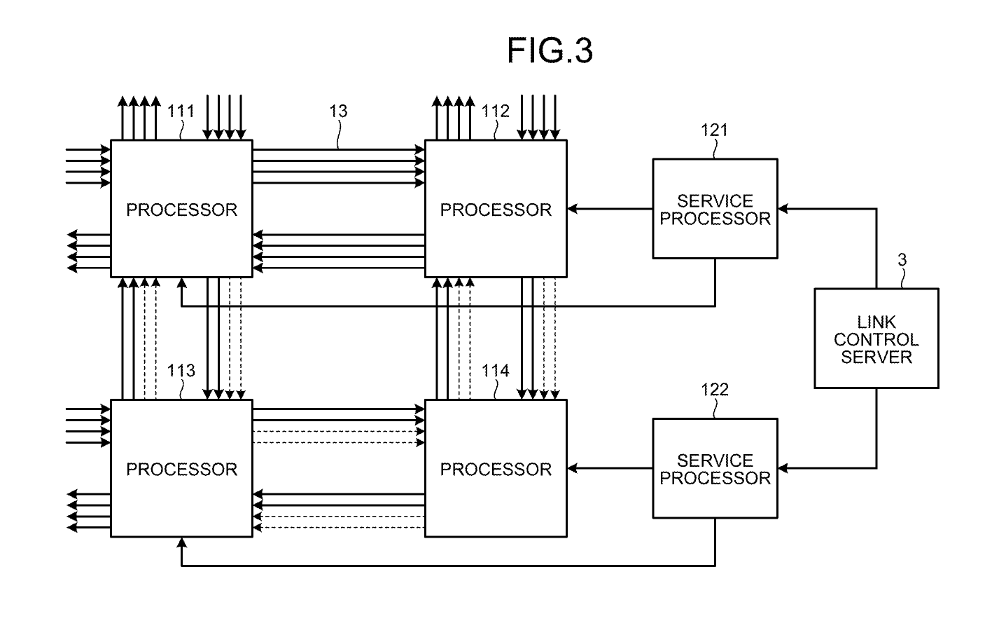

FIG. 3 is a diagram for explaining interconnection paths between processors, and connection of service processors. In FIG. 3, four processors 111 to 114 are illustrated as one example of the processors 11. The processors 11 adjacent to each other, among the processors 111 to 114, are connected through an interconnection path 13. Each of the interconnection paths 13 includes a plurality of lanes (eight lanes, for example). A transmission rate of the interconnection path 13 is fastest when data is transmitted using all lanes. After some of lanes of the interconnection path 13 are degenerated into disuse, the interconnection path 13 can transmit data using the rest of lanes. In the embodiment, data is normally transmitted using all lanes of the interconnection path 13.

In FIG. 3, the processor 111 is connected to the processors 112 and 113, and further connected to other adjacent processors 11 (not illustrated). The processor 112 is connected to the processors 111 and 114, and further connected to another adjacent processor 11 (not illustrated). The processor 113 is connected to the processors 111 and 114, and further connected to another adjacent processor 11 (not illustrated). The processor 114 is connected to the processors 112 and 113. The processors connected through the interconnection path 13 can communicate each other using the interconnection path 13.

Each processor performs arithmetic processing. When three-dimensional simulation of large scale disaster such as tsunami is performed, for example, the processor performs arithmetic processing to reproduce movement of objects in the large scale disaster. In three-dimensional simulation, a partial area of three-dimensional space is allocated to each processor. The processors perform arithmetic calculation of movement of objects in the area allocated thereto.

One service processor is provided for a predetermined number of a plurality of processors. For example, one service processor is arranged for every 102 processors. The service processors each are connected to each of the corresponding processors. The embodiment describes a case in which one service processor is provided for every certain number of processors. However, two service processors may be provided for every certain number of processors.

The service processors are connected to the link control server 3. Each service processor receives an instruction to control the processors from the link control server 3, and controls the corresponding processors in accordance with the received control instruction. The control of the processors by the service processors will be described later in detail.

Returning to FIG. 1, the description will be continued. The job management server 2 includes a job manager 21, a logical coordinate generation unit 22, and a resource management unit 23.

The input device 4 inputs, to the job manager 21, the number of nodes corresponding to the coordinate axes X, Y, and Z that are used for jobs to be executed. In the following, a job to be executed is referred to as an “execution job”. Here, the job is actually executed by the processor 11. In the following description, however, the “node” executes such a job, which indicates that each processor 11 to which the node is allocated executes the job.

The job manager 21 transmits the number of nodes in the X direction, the Y direction, and the Z direction for received execution jobs to the logical coordinate generation unit 22.

Thereafter, the job manager 21 receives a determination result of whether the nodes can be allocated to the processors 11 from the logical coordinate generation unit 22. When the nodes in accordance with jobs to be input cannot be allocated, the job manager 21 waits until the processors 11 are released after another job is finished, for example, and the nodes can be allocated to the necessary number of processors. After waiting during a certain period, the job manager 21 transmits again the number of nodes in the X axis direction, the Y axis direction, and the Z axis direction for the input jobs to the logical coordinate generation unit 22 in order to allocate nodes for the jobs to be executed.

When the nodes are allocated to the processors 11, the job manager 21 receives logical coordinates indicating logical connection of the processors 11 allocated as nodes executing the jobs, from the logical coordinate generation unit 22. Here, the logical coordinates of the processor is represented in correspondence between a node number preliminarily provided to the processor and the logical coordinates determined by the logical coordinate generation unit 22.

The job manager 21 notifies the resource management unit 23 of the logical coordinates of the processors 11 and the number of nodes. Then, the job manager 21 allocates jobs to the actual processors 11 in accordance with the logical coordinates, and notifies the resource management unit 23 of a request for the processors 11 to execute the jobs.

The logical coordinate generation unit 22 includes an interprocessor communication path library 221 storing the physical arrangement and connection of the processors 11. Moreover, the logical coordinate generation unit 22 stores already-used processors 11 among the processors 11 of the parallel computer 1.

The logical coordinate generation unit 22 receives the number of nodes in the X axis direction, the Y axis direction, and the Z axis direction that are required for the execution jobs from the job manager 21. The logical coordinate generation unit 22 can specify a connection form of nodes executing the execution jobs based on the number of nodes corresponding to each coordinate axis. The logical coordinate generation unit 22 acquires processors 11 other than the already-used processors 11 based on the physical arrangement of the processors 11 stored in the interprocessor communication path library 221. Then, the logical coordinate generation unit 22 searches positions where the nodes executing the execution jobs can be arranged. That is, the logical coordinate generation unit 22 determines whether an area corresponding to the connection form of nodes executing the execution jobs can be secured using processors other than the already-used processors 11. When the positions where the nodes executing the execution jobs are secured, the logical coordinate generation unit 22 sends notification to the job manager 21 indicating that the nodes can be allocated.

Here, in the information processing system of the embodiment, nodes arranged on each coordinate plane such as an X-A coordinate plane in six-dimensional space are sequentially connected in a unicursal annular form, as described later, and the node order in a unicursal form is regarded as one coordinate axis. The coordinate plane is regarded as a coordinate axis, whereby when a failure occurs in a node on a coordinate axis, nodes are connected again in a unicursal annular form while avoiding the node having a failure, and the connection toward the direction of the coordinate axis is maintained. In the following description, each coordinate plane such as an X-A coordinate plane is regarded as a coordinate axis.

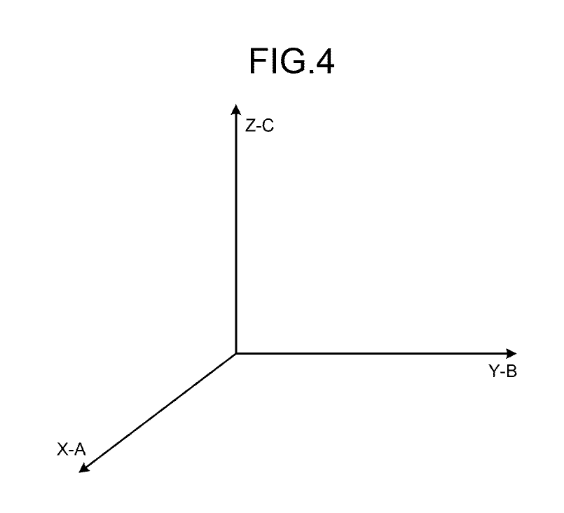

The logical coordinate generation unit 22 generates an X-A axis that is a logical coordinate axis having the X axis and the A axis on which the execution jobs are arranged. The logical coordinate generation unit 22 generates a Y-B axis that is a logical coordinate axis having the Y axis and the B axis on which the execution jobs are arranged. The logical coordinate generation unit 22 generates a Z-C axis that is a logical coordinate axis having the Z axis and the C axis on which the execution jobs are arranged. As described above, the X-A axis, the Y-B axis, and the Z-C axis each form three-dimensional toruses, and secure redundancy. FIG. 4 is a diagram illustrating logical coordinate axes. That is, the logical coordinate generation unit 22 pairs the X axis and the A axis, the Y axis and the B axis, and the Z axis and the C axis, in the six-dimensional coordinate axes illustrated in FIG. 2, and generates three-dimensional logical coordinates illustrated in FIG. 4.

The logical coordinate generation unit 22 uses the processors 11 that are adjacent physically for processors 11 that are adjacent logically. More specifically, the logical coordinate generation unit 22 sequentially allocates logical coordinates of the consecutive number to the processors 11 adjacent physically, and thus generates logical connection. That is, the logical connection is connection indicated by a sequence of logical coordinates. Then, the logical coordinate generation unit 22 connects the processors 11 on the logical coordinate axis to generate annular logical connection, and indicates coordinates on the logical coordinate axis by the generated logical connection. Here, the annular form is a form in which the number of logical coordinates is provided sequentially to the processor 11 so that the processors 11 are connected mutually through the interconnection path 13, and the processor 11 of the first number and the processor 11 of the last number are connected to each other through the interconnection path 13. The logical coordinate axes are defined with two axes. Thus, the logical coordinate generation unit 22 can form annular logical connection by connecting the processors 11 on the logical axes.

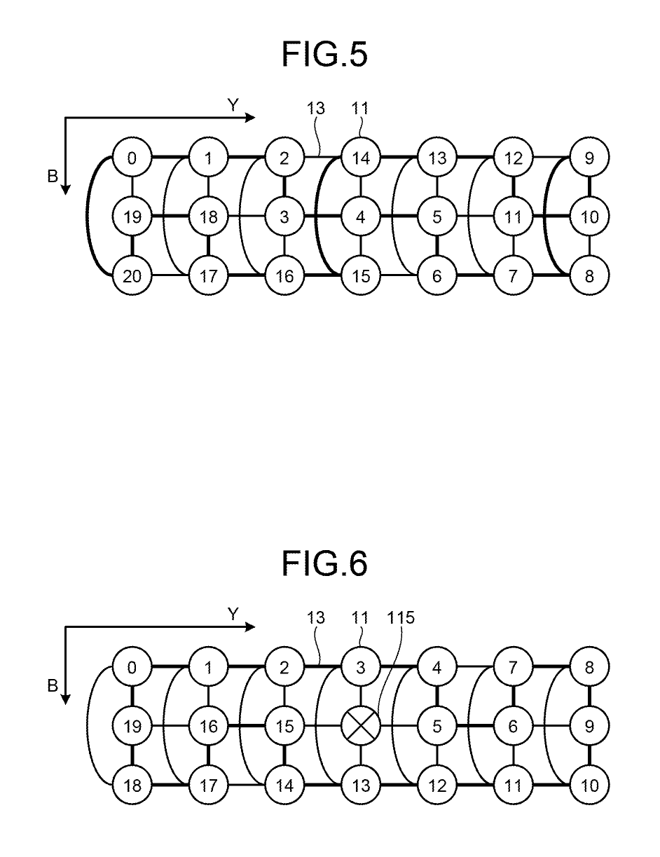

Here, the generation of logical connection is described with reference to FIG. 5 and FIG. 6. FIG. 5 is a diagram illustrating one example of logical connection when no failure occurs in processors. FIG. 6 is a diagram illustrating one example of logical connection when a failure occurs in a processor. Here, the case of Y-B axis is described. The Y-B axis of FIG. 5 and FIG. 6 corresponds to the Y-B axis of FIG. 4. In both FIG. 5 and FIG. 6, a lateral direction corresponds to a Y axis direction, and a vertical direction corresponds to a B axis direction. That is, the processors 11 arranged laterally are in the Y axis direction, and the interconnection paths 13 connecting the processors 11 arranged laterally are interconnection paths extending in the Y axis direction. The processors 11 arranged vertically are in the B axis direction, and the interconnection paths 13 connecting the processors 11 arranged vertically are interconnection paths extending in the B axis direction. Moreover, regarding the processors 11 arranged in a line in the B axis direction in FIG. 5 and FIG. 6, the top processor 11 and the bottom processor 11 are also adjacent to each other, and the processors 11 are connected through the interconnection path 13. That is, the lines connecting the processors 11 represent the interconnection paths 13 in FIG. 5 and FIG. 6.

As illustrated in FIG. 5, when no failure occurs in the processors 11 on the plane in the Y-B axis direction, the logical coordinate generation unit 22 connects all of the processors 11 in a unicursal annular form along the interconnection paths 13. Then, the logical coordinate generation unit 22 selects one processor 11 as the origin among the processors 11 and provides the selected processor 11 with the number 0. Then, the logical coordinate generation unit 22 sequentially provides logical coordinates to each processor 11 along the path connected in a unicursal form. In this manner, the logical coordinate generation unit 22 allocates logical coordinates to the processors 11 on the plane in the Y-B axis direction, as illustrated in FIG. 5. Thus, the direction along the path illustrated by the thick line in FIG. 5 is the Y-B axis direction, and the number provided to each processor 11 represents logical coordinates.

In FIG. 6, a failure occurs in a processor 115 among the processors 11 on the plane in the Y-B axis direction. In this case, the logical coordinate generation unit 22 connects all of the processors 11 except the processor 115 in a unicursal annular form along the interconnection paths 13. Then, the logical coordinate generation unit 22 selects one processor 11 as the origin among the processors 11 other than the processor 115 and provides the selected processor 11 with the number 0. Then, the logical coordinate generation unit 22 sequentially provides logical coordinates to each processor 11 along the path connected in a unicursal form. In this manner, even when a failure occurs in the processor 115, the logical coordinate generation unit 22 can provide logical coordinates to the processors 11 on the plane in the Y-B axis direction, as illustrated in FIG. 6. Thus, the direction along the path illustrated by the thick line in FIG. 6 is the Y-B axis direction, and the number provided to the processors 11 represents logical coordinates.

Then, the logical coordinate generation unit 22 stores correspondence between the node number and the logical coordinates that are allocated to all processors 11.

Thereafter, the logical coordinate generation unit 22 notifies the job manager 21 of the correspondence between the node number and the logical coordinates, and the number of nodes.

The resource management unit 23 preliminarily receives jobs and setting information thereof that are input by an operator from the input device 4. The setting information of jobs includes information of which job is allocated to which node, for example.

The resource management unit 23 acquires the correspondence between the node number and the logical coordinates and the number of nodes from the job manager 21. In addition, the resource management unit 23 receives a job execution request from the job manager 21.

Receiving the job execution request, the resource management unit 23 specifies which job is allocated to which processor group among the processors 11 connected in a unicursal form using the logical coordinates. Then, the resource management unit 23 inputs, to each of the processors 11 of the parallel computer 1, a job allocated thereto.

Next, the resource management unit 23 transmits the correspondence between the node number and the logical coordinates to a coordinate conversion unit 31 of the link control server 3.

The link control server 3 includes the coordinate conversion unit 31, a sub path determination unit 32, a power control unit 33.

The coordinate conversion unit 31 stores the correspondence between the node number and physical coordinates that are six-dimensional coordinates represented by coordinates (X, Y, Z, A, B, C) in six-dimensional coordinate space.

The coordinate conversion unit 31 receives the correspondence between the node number and the logical coordinates from the resource management unit 23. Then, the coordinate conversion unit 31 converts, using the stored correspondence between the node number and six-dimensional physical coordinates (X, Y, Z, A, B, C), the three-dimensional logical coordinates of each processor 11 into six-dimensional physical coordinates based on the received correspondence between the node number and three-dimensional logical coordinates (X-A, Y-B, Z-C).

Then, the coordinate conversion unit 31 notifies the sub path determination unit 32 of the logical coordinates and the physical coordinates of each processor 11 that is a node to which the execution job is allocated.

The sub path determination unit 32 acquires the logical coordinates and the physical coordinates of each processor 11 to which a node executing the execution job is allocated, from the coordinate conversion unit 31.

Then, the sub path determination unit 32 acquires physical coordinates of two processors 11 whose logical coordinates are consecutive, that is, two processors 11 whose logical coordinates are adjacent to each other, and the sub path determination unit 32 determines the interconnection path 13 connecting the acquired physical coordinates to be a main path. Moreover, the sub path determination unit 32 determines the interconnection paths 13 other than the main paths to be sub paths.

The sub path determination unit 32 notifies the power control unit 33 of information of sub paths. Here, the information of sub paths may be pairs of physical coordinates of two processors 11 connected through such a sub path.

The power control unit 33 acquires the information of sub paths from the sub path determination unit 32. Then, the power control unit 33 instructs the service processor 12 controlling the processors 11 connected through sub paths that are objects of degeneration to degenerate a plurality of lanes connecting the processors on the interconnection paths 13 as sub paths. To be more specific, when the processors are connected through M lanes (M is an integer equal to or larger than one), the power control unit 33 makes an instruction to degenerate X lanes (X is an integer equal to or larger than one) and connect the processors through N lanes (N=M−X).

Here, returning to the parallel computer 1, the operation of the processors 11 and the service processors 12 is described.

The processor 11 receives a job allocated thereto from the resource management unit 23. Then, the processor 11 executes the received job. Here, in the embodiment, when the input job is of three-dimensional simulation, for example, the mutual influence between positions near to each other is relatively significant in three-dimensional space as an object of simulation. That is, when the processor 11 executes the job, the communication between nodes whose logical coordinates are adjacent is increased. For example, in the case of logical coordinates such as in FIG. 5 and FIG. 6, the processor 11 frequently performs communication with other processors using the main paths illustrated by the thick lines.

The service processor 12 controlling the processors 11 connected through sub paths receives a lane degeneration instruction as well as information of the sub paths, from the link control server 3.

Then, the service processor 12 instructs the processor 11 connected through the sub paths to degenerate lanes of the interconnection paths 13 as sub paths. For example, the service processor 12 instructs a transmission/reception circuit (not illustrated) of the processor 11 connected through the sub paths as objects of degeneration to reduce lanes to a half.

The processor 11 receives the instruction from the service processor 12, and degenerates lanes of the interconnection paths 13 as instructed.

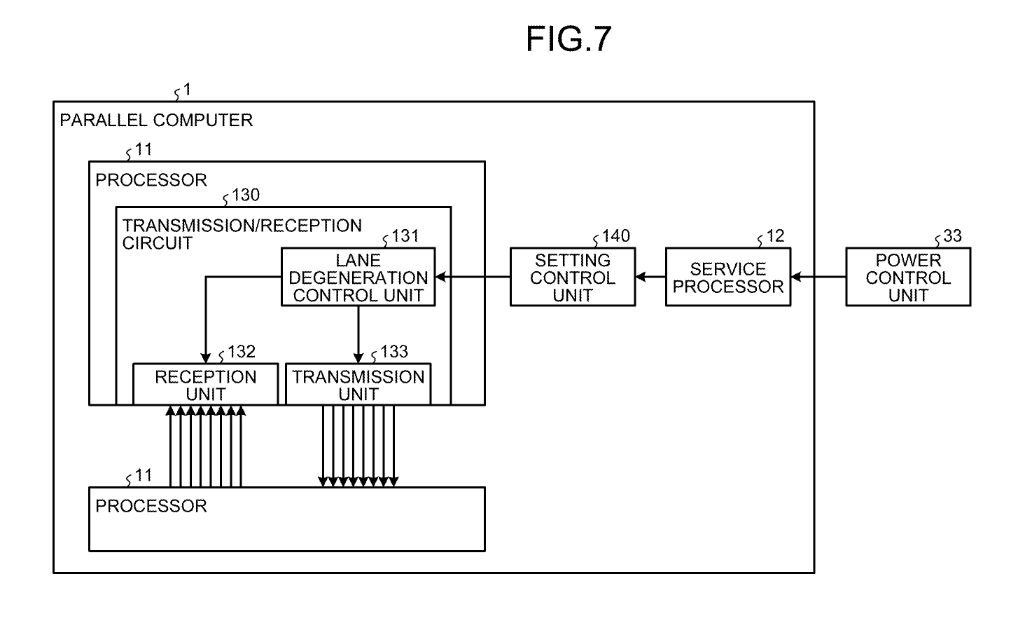

Here, the degeneration of lanes is described with reference to FIG. 3 and FIG. 7. FIG. 7 is a block diagram illustrating details of the parallel computer according to the embodiment. The following describes the case of degenerating lanes of the interconnection paths 13 between the processors 112 and 114, between the processors 111 and 113, between the processors 112 and 114, and between the processors 113 and 114 in FIG. 3.

A service processor 121 receives an instruction to degenerate lanes of the interconnection path 13 between the processors 112 and 114 and the interconnection path 13 between the processors 111 and 113, from the link control server 3. Then, the service processor 121 instructs the processor 111 to reduce lanes of the interconnection path 13 between the processor 111 and the processor 113 to a half. The service processor 121 instructs the processor 112 to reduce lanes of the interconnection path 13 between the processor 112 and the processor 114 to a half.

A service processor 122 receives an instruction to degenerate lanes of the interconnection path 13 between the processors 113 and 111, the interconnection path 13 between the processors 114 and 112, and the interconnection path 13 between the processors 113 and 114, from the link control server 3. Then, the service processor 122 instructs the processor 113 to reduce lanes of the interconnection path 13 between the processor 113 and the processor 111 to a half. The service processor 122 instructs the processor 114 to reduce lanes of the interconnection path 13 between the processor 114 and the processor 112 to a half. Furthermore, the service processor 122 instructs the processors 113 and 114 to reduce lanes of the interconnection path 13 connecting therebetween to a half.

The processor 111 receives the instruction from the service processor 121 and degenerates lanes of the interconnection path 13 between the processor 111 and the processor 113 to a half. Arrows illustrated by broken lines in FIG. 3 represent degenerated lanes. The processor 112 receives the instruction from the service processor 121 and degenerates lanes of the interconnection path 13 between the processor 112 and the processor 114 to a half.

The processor 113 receives the instruction from the service processor 122 and degenerates lanes of the interconnection path 13 between the processors 113 and 111 and the interconnection path 13 between the processors 113 and 114 to a half, respectively. The processor 114 receives the instruction from the service processor 122 and degenerates lanes of the interconnection path 13 between the processors 114 and 112 and the interconnection path 13 between the processors 114 and 113 to a half, respectively.

Here, an example of lane degeneration processing by the processors 11 is described with reference to FIG. 7. FIG. 7 illustrates only two processors 11 in the parallel computer 1 to explain the details of the processors 11. The parallel computer 1 actually includes a number of processors 11, as illustrated in FIG. 1 and FIG. 3.

The parallel computer 1 includes a setting control unit 140 between the service processor 12 and the processor 11. The processor 11 includes a transmission/reception circuit 130. The transmission/reception circuit 130 includes a lane degeneration control unit 131, a reception unit 132, and a transmission unit 133.

The setting control unit 140 receives a lane degeneration instruction from the service processor 12. Then, the setting control unit 140 notifies the lane degeneration control unit 131 of information of interconnection paths as objects of degeneration and information of degeneration degree.

The reception unit 132 receives data using a plurality of lanes in the interconnection paths connected to other processors 11. The transmission unit 133 transmits data using a plurality of lanes of the interconnection paths connected to other processors 11.

The lane degeneration control unit 131 receives the information of interconnection paths as objects of degeneration and the information of degeneration degree from the setting control unit 140. The lane degeneration control unit 131 determines lanes to be degenerated in the interconnection paths as objects of degeneration. Then, the lane degeneration control unit 131 cuts off power supply to the lane determined to be degenerated. Thus, the reception unit 132 and the transmission unit 133 cannot use lanes on which power supply is cut off. The reception unit 132 and the transmission unit 133 perform communication using lanes to which power is supplied.

Here, FIG. 7 illustrates that the transmission/reception circuit 130 performs communication with another processor 11, for convenience of explanation. However, the transmission/reception circuit 130 may perform communication with a plurality of processors 11. In such a case, the transmission/reception circuit 130 preferably includes the reception unit 132 and the transmission unit 133 for each processor 11. In addition, one transmission/reception circuit 130 may be provided for each of other processors 11 with which communication is performed.

Returning to FIG. 3, the description will be continued. The interconnection paths 13 are degenerated by the processors 11 having received the instruction from the service processors 12, whereby all of the interconnection paths 13 as sub paths are degenerated. In FIG. 5 or FIG. 6, for example, the interconnection paths 13 illustrated by the thick lines are main paths, and the interconnection paths 13 illustrated by thin lines are sub paths. In such a case, the processors 11 degenerate the interconnection paths 13 illustrated by thin lines in FIG. 5 or FIG. 6. The power of the transmission/reception circuit driving the paths to the degenerated lanes of the interconnection paths is cut off. Thus, it is possible to reduce power consumption.

As described above, in three-dimensional simulation, for example, the communication is performed frequently between adjacent nodes, but not frequently between nodes not adjacent to each other. That is, a communication amount of the interconnection paths 13 as sub paths other than the main paths representing connection of nodes adjacent to each other logically is small. Thus, even when the lanes of the interconnection paths 13 as sub paths are degenerated, the influence on simulation processing is small, and no problem is caused. Then, it is possible to reduce power consumption by degenerating lanes of the interconnection paths 13 in this manner.

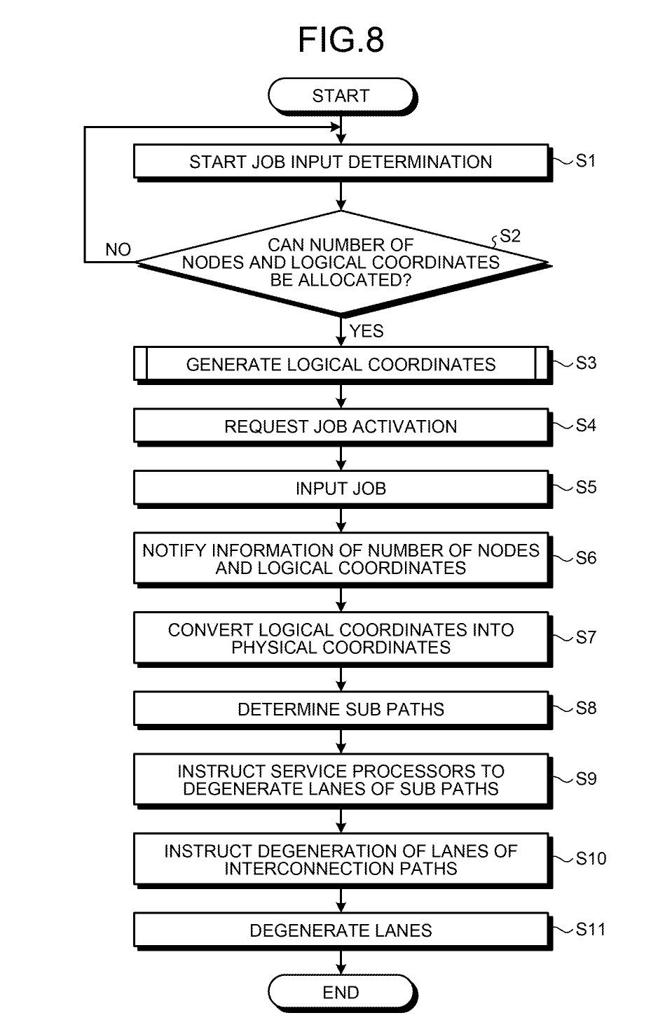

The following will describe processing of degenerating lanes of the interconnection paths 13 in the information processing system of the embodiment with reference to FIG. 8. FIG. 8 is a flowchart illustrating processing of degenerating lanes of the interconnection paths 13 in the information processing system of the embodiment.

The job management server 2 starts job input determination in accordance with a job input instruction input from the input device 4 (Step S1). To be more specific, the job manager 21 receives, from the input device 4, an input of the number of nodes corresponding to the coordinate axes X, Y, and Z that are used for jobs to be executed. Then, the job manager 21 transmits the number of nodes corresponding to the coordinate axes X, Y, and Z that are used for the jobs to the logical coordinate generation unit 22, and instructs the logical coordinate generation unit 22 to generate logical coordinates.

The logical coordinate generation unit 22 receives the number of nodes corresponding to the coordinate axes X, Y, and Z that are used for the jobs from the job manager 21. Then, the logical coordinate generation unit 22 determines whether such a number of nodes and logical coordinates can be allocated using the physical arrangement of the processors 11 and the information of already-used processors 11 that are stored in the interprocessor communication path library 221 (Step S2). When it is difficult to allocate such a number of nodes and logical coordinates (No at Step S2), the processing returns to Step S1, and the logical coordinate generation unit 22 waits until the processors 11 become available.

By contrast, when it is possible to allocate such a number of nodes and logical coordinates (Yes at Step S2), the logical coordinate generation unit 22 generates logical coordinates (Step S3). Then, the logical coordinate generation unit 22 notifies the job manager 21 of information of the generated logical coordinates. Here, the information of the logical coordinates includes correspondence between the node number and the logical coordinates. The following describes the case in which the logical coordinates illustrated in FIG. 5 are generated, for example. Here, the node number of node 0 is allocated to the processor 11 having the logical coordinates 0 in FIG. 5, and the node number increases along the B axis. It is supposed that the node number is allocated so that the processor 11 following the bottom processor 11 in the B axis direction is the top processor 11 in the B axis direction on the next line in the Y axis direction. In this case, the logical coordinate generation unit 22 notifies the job manager 21 of the following information. That is, the node 0 has logical coordinates 0. The node 1 has logical coordinates 19. The node 2 has logical coordinates 20. The node 3 has logical coordinates 1. The node 4 has logical coordinates 18. The node number and the logical coordinates correspond to each other in this manner, and the node 20 has logical coordinates 8 finally. The logical coordinate generation unit 22 notifies the job manager 21 of such information.

The job manager 21 receives notification indicating that the allocation is possible from the logical coordinate generation unit 22, and acquires information of the logical coordinates generated by the logical coordinate generation unit 22. Then, the job manager 21 notifies the resource management unit 23 of the information of the logical coordinates, and requests the resource management unit 23 to activate jobs (Step S4).

The resource management unit 23 receives the job activation request, and inputs, to each of the processors 11 to which the logical coordinates are allocated, a job allocated to each node corresponding to the processor 11 so that the processor 11 executes the job (Step S5).

The resource management unit 23 notifies the coordinate conversion unit 31 of the link control server 3 of the information of the number of nodes and the logical coordinates (Step S6).

The coordinate conversion unit 31 receives the information of the number of nodes and the logical coordinates from the resource management unit 23. Then, the coordinate conversion unit 31 acquires physical coordinates of the processor 11 having each of the logical coordinates based on the information of the logical coordinates, and converts the logical coordinates into physical coordinates (Step S7). Then, the coordinate conversion unit 31 notifies the sub path determination unit 32 of the information of the logical coordinates and the information of physical coordinates corresponding to the logical coordinates.

To be more specific, with respect to the processors 11 as illustrated in FIG. 5, the coordinate conversion unit 31 stores the following correspondence between the node number and the physical coordinates: the node 0=(0, 0, 0, 0, 0, 0) (coordinates (X, Y, Z, A, B, C) are represented in parentheses), the node 1=(0, 0, 0, 0, 1, 0), the node 2=(0, 0, 0, 0, 2, 0), the node 3=(0, 1, 0, 0, 0, 0), the node 4=(0, 1, 0, 0, 1, 0), . . . , the node 20=(0, 6, 0, 0, 2, 0). Then, the coordinate conversion unit 31 converts the logical coordinates into physical coordinates in the following way. That is, the logical coordinates 0 is converted into physical coordinates (0, 0, 0, 0, 0, 0). The logical coordinates 1 is converted into physical coordinates (0, 1, 0, 0, 0, 0). The logical coordinates 2 is converted into physical coordinates (0, 2, 0, 0, 0, 0). The logical coordinates 3 is converted into physical coordinates (0, 2, 0, 0, 1, 0). In this manner, the logical coordinates are sequentially converted, and the logical coordinates 20 is converted into physical coordinates (0, 0, 0, 0, 2, 0) finally.

The sub path determination unit 32 specifies the interconnection paths 13 between the processors 11 having adjacent logical coordinates as main paths, based on the received information of logical coordinates and physical coordinates. Then, the sub path determination unit 32 determines which interconnection paths 13 are sub paths using the specified main paths (Step S8). To be more specific, the sub path determination unit 32 specifies the interconnection paths 13 other than the main paths as sub paths. Then, the sub path determination unit 32 notifies the power control unit 33 of information of the sub paths.

For example, the sub path determination unit 32 determines the interconnection paths 13 indicated by a difference between the physical coordinates of the processors 11 whose logical coordinates are consecutive, to be main paths. In the case of FIG. 5, for example, the logical coordinates 0 and the logical coordinates 1 are (0, 0, 0, 0, 0, 0) and (0, 1, 0, 0, 0, 0), respectively, when represented in physical coordinates. That is, the Y coordinate is shifted from 0 to 1. Then, the sub path determination unit 32 determines the interconnection path 13 through which the Y coordinate of the processor 11 at the physical coordinates (0, 0, 0, 0, 0, 0) is shifted from 0 to 1, to be a main path. Similarly, the logical coordinates 1 and the logical coordinates 2 are (0, 1, 0, 0, 0, 0) and (0, 2, 0, 0, 0, 0), respectively, when represented in physical coordinates. That is, the Y coordinate is shifted from 1 to 2. Then, the sub path determination unit 32 determines the interconnection path 13 through which the Y coordinate of the processor 11 at the physical coordinates (0, 1, 0, 0, 0, 0) is shifted from 1 to 2, to be a main path. In this manner, the sub path determination unit 32 repeats specification of main paths. Then, the sub path determination unit 32 determines the interconnection paths other than the specified main paths to be sub paths.

The power control unit 33 acquires information of the sub paths from the sub path determination unit 32. Then, the power control unit 33 instructs the service processor 12 to degenerate lanes of sub paths (Step S9).

The service professor 12 receives the instruction to degenerate lanes of sub paths from the power control unit 33. Then, the service processor 12 instructs the processors 11 connected through the interconnection paths 13 as sub paths to degenerate lanes (Step S10).

The processor 11 degenerates lanes of the interconnection paths 13 specified by the service processor 12 (Step S11).

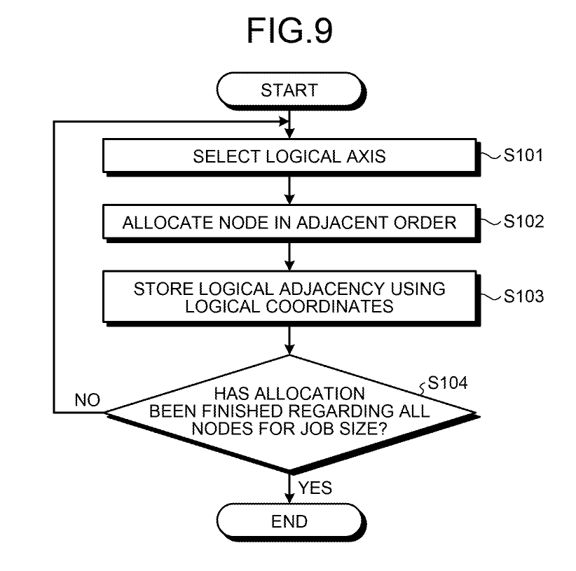

Subsequently, the generation of logical coordinates will be described with reference to FIG. 9. FIG. 9 is a flowchart illustrating processing of generating logical coordinates.

The logical coordinate generation unit 22 generates logical axes using every two coordinate axes of six coordinate axes representing six dimensions. Then, the logical coordinate generation unit 22 selects one logical axis among the generated logical axes (Step S101).

The logical coordinate generation unit 22 sequentially provides logical coordinates to the processors 11 on the selected logical axis so that the adjacent processors 11 have the consecutive numbers of logical coordinates, and allocates nodes thereto (Step S102).

Then, the logical coordinate generation unit 22 stores the logical coordinates, thus storing which processors 11 are adjacent to each other logically (Step S103).

Thereafter, the logical coordinate generation unit 22 determines whether the allocation of the logical coordinates has been finished regarding all nodes for a job size (Step S104). When the allocation of the logical coordinates regarding all nodes for a job size has not been finished (No at Step S104), the logical coordinate generation unit 22 returns the processing to Step S101.

By contrast, when the allocation of the logical coordinates regarding all nodes for a job size has been finished (Yes at Step S104), the logical coordinate generation unit 22 finishes generation of logical coordinates.

As is described above, the information processing system of the embodiment degenerates interconnection paths between processors other than the processors whose logical coordinates are adjacent to each other. In this manner, the information processing system of the embodiment can limit a band width of interconnection paths having a small communication amount while maintaining a band width of the main paths that are interconnection paths having a large communication amount. Thus, the information processing system of the embodiment can reduce power consumption while maintaining the performance of arithmetic processing. In particular, in three-dimensional simulation, for example, most of communication is performed between nodes adjacent to each other. Thus, the information processing system of the embodiment makes it possible to suppress power consumption while securing the performance of simulation processing.

### MODIFICATIONS

In the embodiment, the power control unit 33 reduces power consumption by degenerating lanes of the interconnection paths 13. However, another method may be also applied. For example, the power control unit 33 may reduce power consumption by lowering a frequency of data transfer.

In this case, the power control unit 33 instructs the service processors 12 to lower a frequency of data transmission and reception between the processors 11 connected through the interconnection paths 13 as sub paths.

The service processor 12 instructs each of the processors 11 connected through the sub paths specified by the power control unit 33 to lower a frequency of data transmission and reception therebetween.

The processor 11 receives, from the service processor 12, the instruction to lower a frequency of data transmission and reception to and from other processors 11 to which the processor 11 is connected through sub paths. Then, the processor 11 performs communication through main paths at a maximum speed while performing communication with other processors 11 to which the processor 11 is connected through sub paths at a frequency lower than a frequency used for data transmission and reception through the main paths.

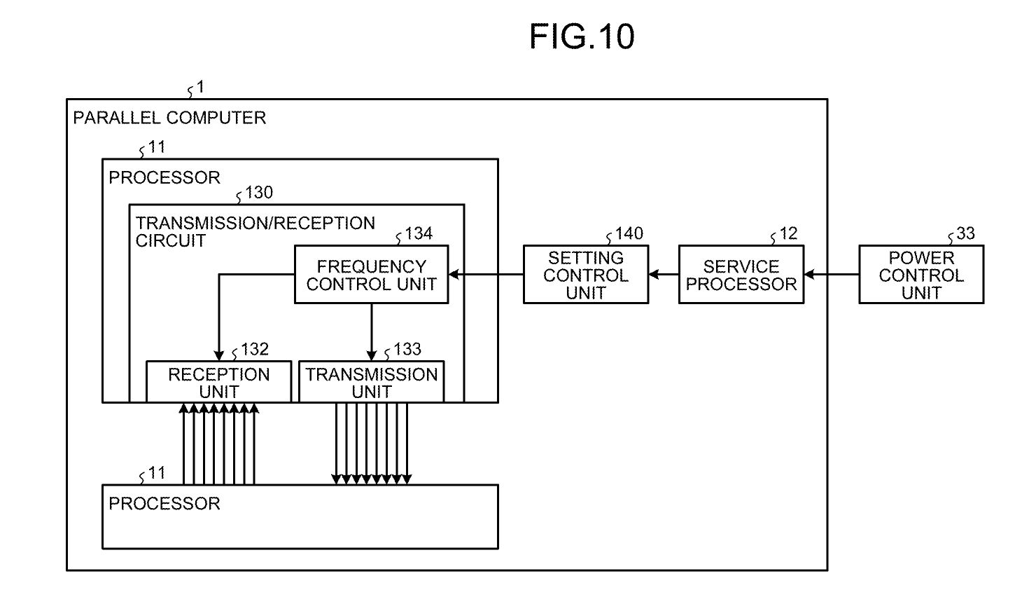

FIG. 10 is a block diagram illustrating details of a parallel computer according to a modification. The transmission/reception circuit 130 includes a frequency control unit 134, a reception unit 132, and a transmission unit 133.

The setting control unit 140 receives a lane degeneration instruction from the service processor 12. The setting control unit 140 specifies interconnection paths to be controlled. Then, the setting control unit 140 notifies the frequency control unit 134 of information of the specified interconnection paths and a frequency used in communication using the interconnection paths. Here, the frequency specified by the setting control unit 140 is lower than a frequency used in data transmission and reception through main paths.

The reception unit 132 receives data from other processors 11 through the interconnection paths using the frequency specified by the frequency control unit 134. The transmission unit 133 transmits data to other processors 11 through the interconnection paths using the frequency specified by the frequency control unit 134.

The frequency control unit 134 receives, from the setting control unit 140, information of the interconnection paths on which a frequency of data transmission and reception is to be lowered and information of a frequency to be used. The frequency control unit 134 notifies the reception unit 132 and the transmission unit 133 performing communication through the specified interconnection paths of the frequency to be used in data transmission and reception.

In this manner, the data transmission and reception is performed at a lower frequency on sub paths than main paths, whereby power consumption can be reduced.

Moreover, in the embodiment, all lanes of the interconnection paths are used as an initial state, and the lanes are reduced from such a state. However, it is possible, in the opposite way, that the lanes used in an initial state are reduced and the lanes used on main paths are increased.

The above description have explained an example case in which the processors are six-dimensionally arranged in the parallel computer. However, the degree is not limited thereto as long as coordinate axes having redundancy are set and main paths are determined on such coordinate axes. For example, the processors may be four-dimensionally arranged so that redundancy is provided only in one-dimensional direction among three dimensions. In the case of two-dimensional simulation, the processors may be three-dimensionally arranged so that redundancy is provided only in one-dimensional direction.

Moreover, in the above description, the job management server 2 and the link control server 3 are separate servers, as illustrated in FIG. 1. Thus, a network for job control is separate from a network for power control. However, the job management server 2 and the link control server 3 may be integrated as one server.

Moreover, the job management server 2 may be provided with the functions of the link control server 3, so that the job management server 2 determines sub paths and instructs the processors 11 to perform degeneration through the network for control, while the processors 11 having received the instruction degenerate lanes of the interconnection paths 13.

Hardware Configuration

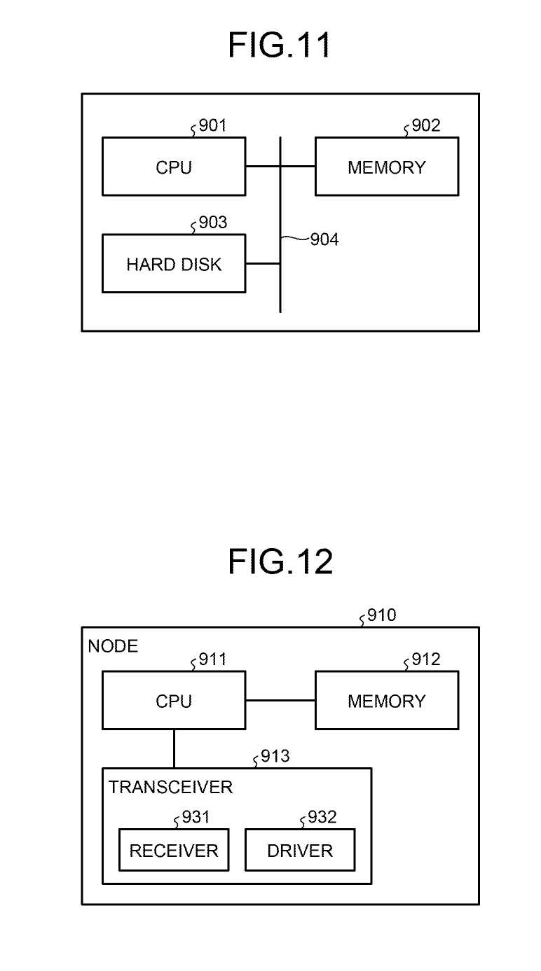

FIG. 11 is a diagram illustrating one example of a hardware configuration of a job management server and a link control server. Both the job management server 2 and the link control server 3 can be achieved by a hardware configuration illustrated in FIG. 11.

The job management server 2 and the link control server 3 include a central processing unit (CPU) 901, a memory 902, and a hard disk 903, as illustrated in FIG. 11, for example.

The CPU 901, the memory 902, and the hard disk 903 are connected to one another through a bus 904.

The hard disk 903 of the job management server 2 stores various programs such as programs achieving the functions of the job manager 21, the logical coordinate generation unit 22, and the resource management unit 23 that are illustrated in FIG. 1 as an example. Moreover, the hard disk 903 stores the interprocessor communication path library 221.

The hard disk 903 of the link control server 3 stores various programs such as programs achieving the functions of the coordinate conversion unit 31, the sub path determination unit 32, and the power control unit 33 that are illustrated in FIG. 1 as an example.

The CPU 901 and the memory 902 of the job management server 2 achieve the functions of the job manager 21, the logical coordinate generation unit 22, and the resource management unit 23. For example, the CPU 901 reads out various programs stored in the hard disk 903, loads, onto the memory 902, a process achieving the functions of the job manager 21, the logical coordinate generation unit 22, and the resource management unit 23, and executes the process.

The CPU 901 and the memory 902 of the link control server 3 achieve the functions of the coordinate conversion unit 31, the sub path determination unit 32, and the power control unit 33. For example, the CPU 901 reads out various programs stored in the hard disk 903, loads, onto the memory 902, a process achieving the functions of the coordinate conversion unit 31, the sub path determination unit 32, and the power control unit 33, and executes the process.

Furthermore, FIG. 12 is a diagram illustrating one example of a hardware configuration of each node in the parallel computer. As illustrated in FIG. 12, a node 910 includes a CPU 911, a memory 912, and a transceiver 913.

The memory 912 and the transceiver 913 are connected with the CPU 911 through buses.

The transceiver 913 includes a receiver 931 and a driver 932. The transceiver 913 achieves the functions of the transmission/reception circuit 130 illustrated in FIG. 7 and FIG. 10, for example.

The driver 932 transmits data to other nodes through the interconnection paths. The driver 932 achieves the function of the transmission unit 133 illustrated in FIG. 7 and FIG. 10, for example.

The receiver 931 receives data from other nodes through the interconnection paths. The receiver 931 achieves the function of the reception unit 132 illustrated in FIG. 7 and FIG. 10, for example.

The CPU 911 and the memory 912 perform arithmetic processing in accordance with an allocated job.

One aspect of the information processing system, the control apparatus, and the method of controlling the information processing system of the application exerts the effect of reducing power consumption.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing system, comprising:
an information processing device that includes a plurality of arithmetic processing units connected through transmission paths to each other;
a management device that determines a communication path passing the transmission paths connecting a certain number of arithmetic processing units in accordance with jobs to be input among the arithmetic processing units, and inputs the jobs to the certain number of arithmetic processing units connected through the determined communication path; and
a control apparatus that controls transmission/reception circuits of the arithmetic processing units connected through the transmission paths not included in the communication path among the transmission paths connecting the arithmetic processing units.

2. The information processing system according to claim 1, wherein the management device determines the communication path passing the transmission paths connecting the certain number of arithmetic processing units so that the communication path is annular.

3. The information processing system according to claim 1, wherein the management device determines the communication path passing the transmission paths connecting the certain number of arithmetic processing units so that the communication path is unicursal.

4. The information processing system according to claim 1, wherein
the arithmetic processing units are arranged so that physical positions of the arithmetic processing units are specified using coordinate values of a plurality of coordinate axes, and
the management device determines the communication path using pairs of logical coordinates corresponding to two mutually different coordinate axes among the coordinate axes.

5. The information processing system according to claim 4, wherein
the arithmetic processing units are arranged so that physical positions of the arithmetic processing units are specified using coordinate values of six coordinate axes, and
the management device determines the communication path using pairs of logical coordinates corresponding to two mutually different coordinate axes among the six coordinate axes.

6. The information processing system according to claim 1, wherein
each of the transmission paths includes a plurality of lanes, and
the control apparatus controls the transmission/reception circuits of the arithmetic processing units connected through the lanes of each of the transmission paths not included in the communication path to increase and decrease the number of lanes used in communication among the lanes.

7. The information processing system according to claim 1, wherein the control apparatus controls the transmission/reception circuits of the arithmetic processing units connected through the transmission paths not included in the communication path to increase and decrease a frequency of the transmission paths not included in the communication path.

8. A control apparatus that is connected to an information processing device that includes a plurality of arithmetic processing units connected through transmission paths to each other, and a management device that determines a communication path passing the transmission paths connecting a certain number of arithmetic processing units in accordance with jobs to be input among the arithmetic processing units and inputs the jobs to the certain number of arithmetic processing units connected through the determined communication path, wherein
the control apparatus controls transmission/reception circuits of the arithmetic processing units connected through the transmission paths not included in the communication path among the transmission paths connecting the arithmetic processing units.

9. A method of controlling an information processing system that comprises an information processing device including a plurality of arithmetic processing units connected through transmission paths to each other, the method comprising:
determining, by a management device included in the information processing system, a communication path passing the transmission paths connecting a certain number of arithmetic processing units in accordance with jobs to be input among the arithmetic processing units, and inputting, by the management device, the jobs to the certain number of arithmetic processing units connected through the determined communication path; and
controlling, by a control apparatus included in the information processing system, transmission/reception circuits of the arithmetic processing units connected through the transmission paths not included in the communication path among the transmission paths connecting the arithmetic processing units.
